(19) United States
(12) Patent Application Publication
(10) Pub. No.: US 2002/0143736 A1
(43) Pub. Date: Oct. 3, 2002

(54) Data mining page and image archive files

(75) Inventor: Valentine C. Krzyzaniak, Federal Way, WA (US)

Correspondence Address: Frederick A. Kaseburg, GRAYBEAL JACKSON HALEY LLP, Suite 350, 155 - 108th Avenue NE, Bellevue, WA, 98004-5901, US

(73) Assignee: CDCOM, Inc.

(21) Appl. No.: 10/056,529

(22) Filed: Jan. 23, 2002

Related U.S. Application Data
(60) Provisional application No. 60/265,439, filed on Jan. 30, 2001.

(51) Int. Cl. G06F 7/00; G06F 17/30

(52) U.S. Cl. 707/1

(57) ABSTRACT

The present invention provides a computer-implemented process for extracting information from a Page/image Archive (PIA) file. An embodiment of the invention includes a computer-readable medium having computer-executable instructions that cause a computer to receive at least one user-selected parameter related to the information to be extracted from the PIA file. The computer also receives the PIA formatted file and converts it to a file format suitable for extraction of information based upon the user-selected parameter. The computer further extracts information from the converted PIA file based on the user-selected parameter; and exposes the extracted information. The instructions may also include exposing the extracted information to a computer-implemented process that uses statistical algorithms to discover patterns and correlations in the extracted information. The present invention also provides a computer-implemented process for extracting information from a PIA file.

### PRIORITY

This application claims priority from Provisional Patent Application No. 60/265,439 filed Jan. 30, 2001.

### BACKGROUND OF INVENTION

The present invention relates to using text data mining techniques on Page/image Archive files. More specifically the present invention relates to the process of retrieving computer friendly data from human friendly text-based report pages that have been stored inside of Page/image Archive files on a computer.

### SUMMARY OF THE INVENTION

The present invention provides a computer-implemented process for extracting information from a Page/image Archive (PIA) file. An embodiment of the invention includes a computer-readable medium having computer-executable instructions that cause a computer to receive at least one user-selected parameter related to the information to be extracted from the PIA file. The computer also receives the PIA formatted file and converts it to a file format suitable for extraction of information based upon the user-selected parameter. The computer further extracts information from the converted PIA file based on the user-selected parameter; and exposes the extracted information. The instructions may also include exposing the extracted information to a computer-implemented process that uses statistical algorithms to discover patterns and correlations in the extracted information.

An embodiment of the present invention also provides a computer-implemented process for extracting information from a Page/image Archive (PIA) file. The process includes receiving at least one user-selected parameter related to the information to be extracted from the PIA file and receiving the PIA formatted file. The process includes converting the PIA file to a file format suitable for extraction of information based upon the user-selected parameter, extracting information from the converted PIA file based on the user-selected parameter, and exposing the extracted information. The process may also include exposing the extracted information to a computer-implemented process that uses statistical algorithms to discover patterns and correlations in the extracted information.

An embodiment of the present invention further provides a computer system for extracting information from a Page/Image Archive (PIA) file in response to a user-selected parameter and exposing it to a tool for discovery of implicit, previously unknown, and potentially useful information. The system includes a processor and a memory storage device coupled to the processor for maintaining the PIA file and the user-selected parameter. The processor is operative to receive at least one user-selected parameter related to the information to be extracted from the PIA file, receive the PIA formatted file, convert the PIA file to a file format suitable for extraction of information based upon the user-selected parameter, extract information from the converted PIA file based on the user-selected parameter; and expose the extracted information.

### BRIEF DESCRIPTION OF THE DRAWINGS

The features of the present invention which are believed to be novel are set forth with particularity in the appended claims. The invention, together with further objects and advantages thereof, may best be understood by making reference to the following description taken in conjunction with the accompanying drawings, in the several figures of which like referenced numerals identify identical elements, and wherein:

FIG. 1: A simple human friendly report that contains information that may be useful for Data Mining. In this case a bill of sale with item prices, order totals, and grand totals.

FIGS. 2a and 2b: The same bill of sale from FIG. 1 in a simple Page/image Archive format. Areas that might be useful for Data Mining are surrounded in dashed boxes.

FIG. 3: A simple embodiment of a computer friendly format that the text data mining might use to store data that it gets from the human friendly information.

FIG. 4: A flow chart of the Page/image Archive data mining process.

### DETAILED DESCRIPTION OF THE PREFERRED EMBODIMENTS

Briefly stated, Page/image Archive Data Mining uses text data mining techniques to extract information from a Page/image Archive (PIA) file and make the information available for discovery of implicit, previously unknown, and potentially useful information from the PIA file to any Knowledge Discovery in Databases (KDD) tool. The PIA file is converted to a traditional text-based file format, and then user-selected data is extracted from the text and placed in a computer friendly file format (usually a database). This process includes the following three steps: retrieving an individual page from the PIA file; the user indicating what data they want retrieved from the page; and extracting data from the text information. In an alternative embodiment, the second step may be performed in multiple parts, with one part performed by a user specifying how to retrieve data from a page, and another part performed by selecting which data items are to be extracted for analysis.

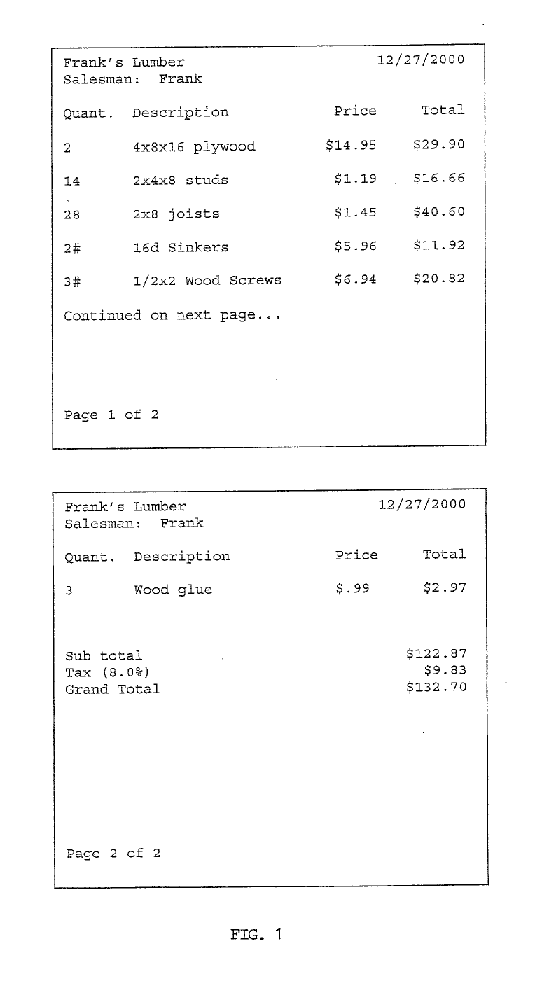

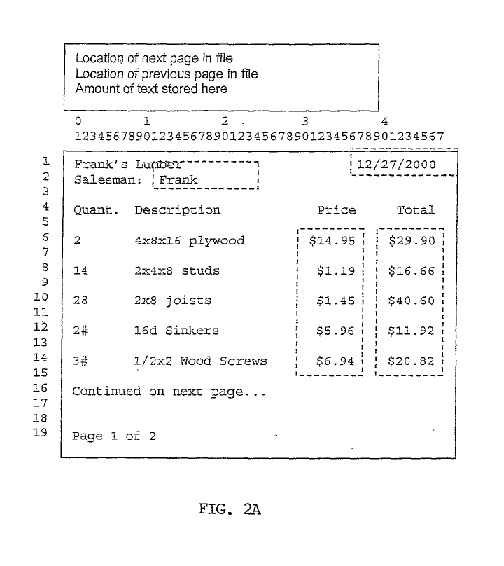

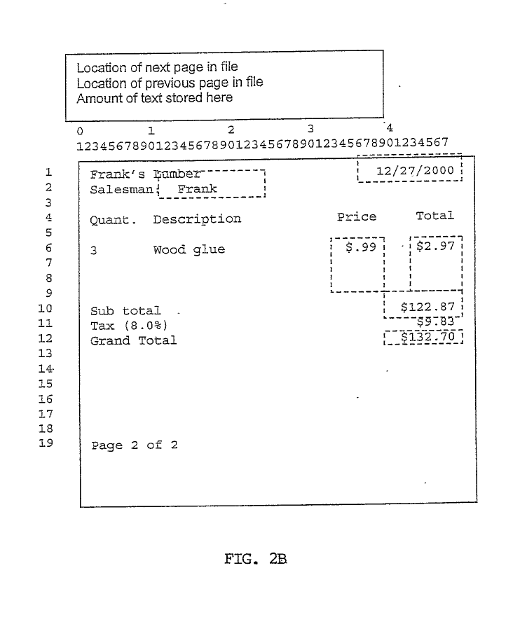

Data Mining is the process of discovering new facts from existing data in computer databases. Text data mining is the process of discovering new facts from existing human readable text information, usually computer-based reports in a simple page or image archive format (referred to herein as “PIA format”). A specific field of text data mining is devoted to retrieving computer friendly data from human friendly information. FIG. 1 is a sample two page, human friendly document in PIA format. For instance, a bill of sale has a lot of information in human readable form (see FIGS. 1 and 2). However, the computer cannot use this information directly, and so the raw data must be extracted and put into computer friendly form. Once the data is in computer friendly form, KDD/software can then be used to perform data analysis.

Page/image Archives store each page of a text-based document in such a way as to make retrieval of a single page easy for the computer, however the text information is still in human readable form (see FIG. 2). PIA formatted files are usually used to store on a digital medium (such as a computer hard disk drive), the reports, invoices, and other documents that are traditionally printed to paper. To continue with the bill of sale example, page one of the bill would be stored in the PIA format with marking information so that the computer can find page one easily (similar to tagging a page with a Post-it Note), page two would be stored separately with it's own marking information.

Because PIA formatted files store this marking information, it prevents traditional text data mining solutions from retrieving computer friendly data from these files.

FIG. 2 is a sample Page/image Archive formatted file and the information that might be text data mined. Boxes denote areas that would be useful to data mine. In this embodiment, each page is preceded by information that tells the computer where the next and previous pages are stored, and how much space the text that follows actually uses.

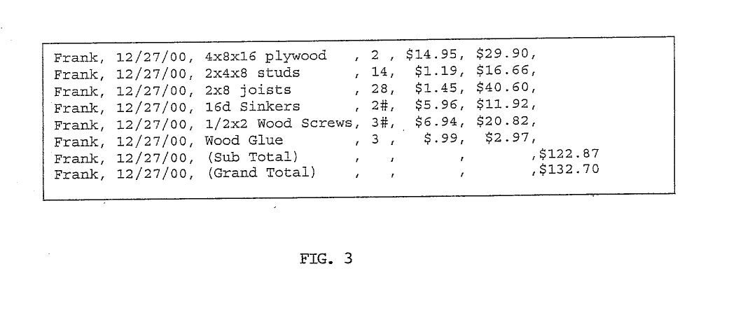

FIG. 3 illustrates one possible embodiment for the data-mined output of the previous Page/image Archive. Each line represents a record, with eight records shown in this example. Each column (separated by commas) is a field with a specific meaning. The fields are Salesman, Date, Description, Quantity, Price, Total Price, Sub and Grand Totals. Note on the last two records the Description field specifies Sub and Grand Totals.

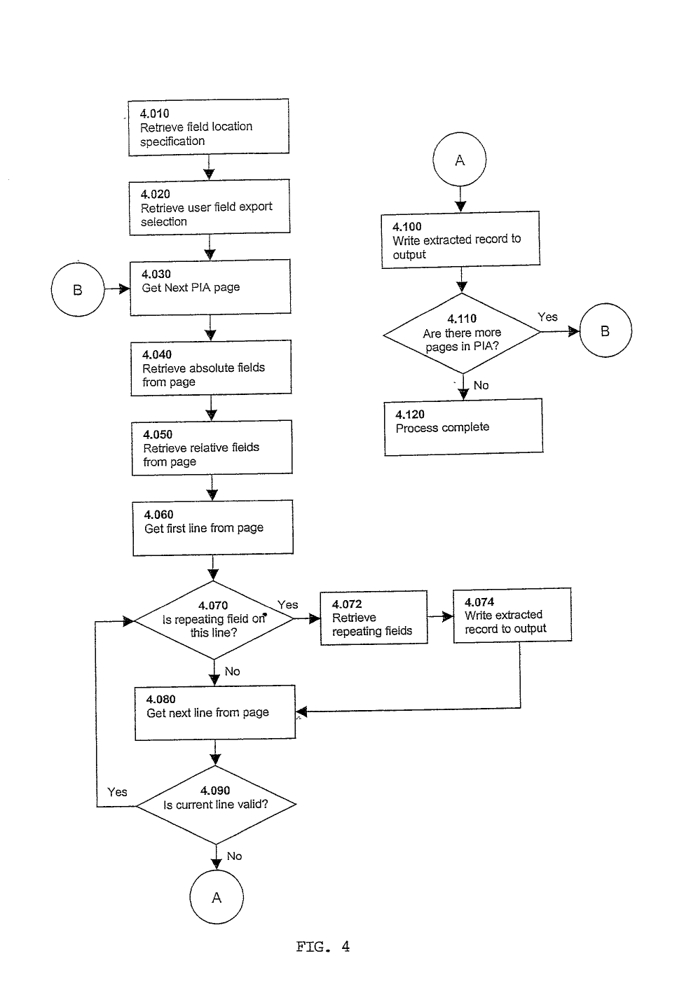

FIG. 4 is a flow chart of the Page/Image Archive data mining process.

Computer-Based Reports

Computers are used extensively to create reports for companies and businesses. These reports contain data presented in an orderly fashion to provide information in human readable form (such as payroll reports or bills of sale). A process or program takes data, usually from a database, and creates a report that can be viewed on a computer screen, printed to a computer printer, or saved to a file. Report generation processes can also create their own data by performing mathematical calculations on certain data elements, or just by presenting the data in a new form.

Text Data Mining

Strictly speaking, text data mining is the entire process of discovering new facts from existing human readable information. However, common use has expanded this term to also refer to any sub-process that is used in this overall process. In this application, “data mining” is used to refer to the process that extracts raw data from human readable text, and places it in a separate file to be imported into another software package for analysis.

Text data mining uses a saved report file to obtain the raw data that is contained in the report. This includes any data that was created by the report generation process. This data is then used however the user wishes, but it is usually imported into the users own KDD software for analysis.

Page/Image Archive Storage of Reports

Page/Image Archive files (PIA) store each report page separately in a file. Because of this separation, it is easier for the computer to access a particular page or a PIA file than it is for the computer to access a particular page in a “Flat File” which stores a multi-page document as a single file, either with or without indications of page breaks. In situations where users view reports a whole page at a time, this format makes sense to store reports for archival. PIA Files can also store images within their records. This is most useful for non-computer-based reports (i.e. reports that have been scanned in from paper), or for images of pre-printed forms that will be merged with the report text. One commercially available implementation of a PIA file is called a D File. When specific examples of PIA files are given below it should be assumed that they are referring to the D File format. Of course, this invention can be easily adapted to any PIA format available.

The following C++ code sample illustrates how to retrieve a page of human readable text from a D File. Note: this code returns a standard CR/LF terminated page of text from the D File, and would need to be further parsed into row/column information. A routine similar to this might be used for step 4.030 in FIG. 4.

const std::string GetPage(std::istream& DFile, mt PageNum)
{

| | |
|---|---|
| CDCCompression Compression; | //Compression handling routines |
| std::string text; | //Variable to hold the uncompressed data |
| std::vector<unsigned char> Data; | //Buffer for reading in compressed data |
| char Header[32]; | //132 byte D File header |

| | |
|---|---|
| SegmentHeader PageHeader; | //Structure defining the fields of a page record |

| | |
|---|---|
| DFile.read(Header,32); | //Read in D File header |

//Read through the form images, as we don't need them

DFile read (reinterpret_cast<char*>(&PageHeader), sizeof (PageHeader));
while (DFile.good() && PageHeader.NextSegment != 0)
{

DFile.seekg (PageHeader.NextSegment);
DFile read (reinterpret_cast<char*>(&PageHeader),sizeof (PageHeader));

}
DFile.seekg(DFile.tellg() + PageHeader.SegmentSize - sizeof (PageHeader));

//Since we have read all the form images, we are now at the first page of text

//Read in the page header
DFile read (reinterpret_cast<char*>(&PageHeader),sizeof (PageHeader));
PageNum--;
//Loop while there's still more file, AND we're still not at the right page
while(DFile.good() && PageNum > 0)
{

//Skip over page data
DFile.seekg(PageHeader.NextSegment);
//Read in the page header
DFile.read (reinterpret_cast<char*>(&PageHeader),sizeof (PageHeader));
PageNum- -;

}
//Read in the compressed page data
Data.resize(PageHeader.DataSize, 0);
DFile.read(Data.begin(),Data.size());
//Decompress it
Compression.Decompress (text,Data);
//Return the decompressed data
return text;

}

Data Extract Overview

Not all information on a report page is relevant to a computer. Words like salesman and page are part of the information on a page but are not part of the raw data.

Data occurs on a report page in three ways. Absolute Data occurs once in the same spot on each page, such as “Date” or “Salesman” in FIG. 2. Repeating Data occurs multiple times on a page, such as “Price” or “Total” in FIG. 2. Relative Data occurs once on a page, but is not in the same spot, such as “Sub total” and “Grand Total” in FIG. 2. Note: not all data occurs on every page, such as “Grand Total” in FIG. 2.

Specifying data location for extract from Page/Image Archive page

The user selects the parameters for the information to be data mined based upon how PIA formatted files are laid out. This section describes how the information is specified for step 4.010 in FIG. 4.

Specifying the location of an absolute field is as simple as specifying row, column and length of the data. For example, in FIG. 2, the “Salesman” field would be specified as row 2, column 12, and length 20. Length can sometimes appear to be longer than necessary because fields like name need to accommodate every possible name that may appear there. Some software implementations can calculate the length automatically by detecting the blank spaces that occur after “name”.

Repeating data is a little more complex to deal with. Where absolute data only requires one access to the page, repeating data requires repeated access to the page. Repeating data is extracted by looping through each line of text on a page and checking, through various means, if the line contains the field of data or not.

When specifying repeating data you still need column and length. For example, the “Total” field in FIG. 2 would be column 39 and length 8.

Row ranges can be specified for repeating data. For the “Total” field in FIG. 2A, rows 6 through 14 contain valid fields, so these would be the valid rows. The extractor may or may not ignore the blank field entries on the odd row numbers for the total field depending on the implementation.

Row range provides problems where different fields exist within the same range of rows. For example in FIG. 2B, “Sub total”, “Tax”, and “Grand Total” all occur within the range previously specified for “Total” (rows 6 through 14). In these circumstances, a test can be performed to determine if a field is valid. Only extracting “total” when column 34 (the “Price” column) contains a decimal point (.) will provide us with just total price, and not “Sub total” or “Grand Total”. Column 34 is used over column 44 as the latter would still extract “Sub total” and “Grand Total” (which also have decimal points in column 44), whereas the “Price” field's decimal only occurs on lines with valid “Total” fields.

Finally, relative fields (see previous section) can be located by using a search string. The field is then located a certain number of rows and/or columns away from where this search string occurs on the page. For example, to specify “Sub total” in FIG. 2B, you could use a search string of “Sub total”, a row offset of 0, a column offset of 29, and a length of 8.

Performing Data Extract

When the user is specifying data for extraction, they are telling the data extract process where to locate the data, and what data is available for extract. The end user may not need all of the data available in a report. At this point the user will select which fields they want to extract from the fields made available by the location specification. The export selection is step 4.020 in FIG. 4.

Absolute and relative fields are located once (steps 4.040 and 4.050) as those types of fields only occur once on a page. Each line of the page is examined, and checked to see if a repeating field occurs on that line (4.060 through 4.090). If repeating fields are found, they are extracted and written to the output file (steps 4.072 and 4.074, also see FIG. 3 for output file). After all lines have been examined, another output record is written (step 4.100) to ensure that absolute and relative fields get written, even if there were no repeating fields. If more pages are located in the PIA file, the next page is retrieved and the steps are repeated (step 4.110), otherwise data mining is complete.

Process Summary

At this point data mining is complete, and the user will import the output from the process into their favorite KDD software to examine and process the data.

Thus, the present invention is presently embodied as a method, apparatus, computer program or computer readable media encoding a program for data mining user-selected information from PIA files. While particular embodiments of the present invention have been shown and described, modifications may be made, and it is therefore intended in the appended claims to cover all such changes and modifications which fall within the true spirit and scope of the invention.

The following invention is claimed:

1. A computer-readable medium having computer-executable instructions for extracting information from a Page/Image Archive (PIA) file in response to a user-selected parameter, which when executed by a computer:
receive at least one user-selected parameter related to the information to be extracted from the PIA file;
receive the PIA formatted file;
convert the PIA file to a file format suitable for extraction of information based upon the user-selected parameter;
extract information from the converted PIA file based on the user-selected parameter; and
expose the extracted information.

2. The computer-readable medium of claim 1, wherein the extracted information is exposed a computer process that uses statistical algorithms to discover patterns and correlations in the extracted information.

3. A computer implemented process for extracting information from a Page/Image Archive (PIA) file in response to a user-selected parameter and, comprising:
receiving at least one user-selected parameter related to the information to be extracted from the PIA file;
receiving the PIA formatted file;
converting the PIA file to a file format suitable for extraction of information based upon the user-selected parameter;
extracting information from the converted PIA file based on the user-selected parameter; and
exposing the extracted information.

4. The computer-implemented process of claim 3, wherein the extracted information is exposed to a computer process that uses statistical algorithms to discover patterns and correlations in the extracted information.

5. A computer system for extracting information from a Page/Image Archive (PIA) file in response to a user-selected parameter and exposing it to a tool for discovery of implicit, previously unknown, and potentially useful information, comprising:
a processor:
a memory storage device coupled to the processor for maintaining the PIA file and the user-selected parameter;
the processor being operative to conduct the following tasks:
receive at least one user-selected parameter related to the information to be extracted from the PIA file;
receive the PIA formatted file;
convert the PIA file to a file format suitable for extraction of information based upon the user-selected parameter;
extract information from the converted PIA file based on the user-selected parameter; and
expose the extracted information.
